(19) United States
(12) Patent Application Publication
(10) Pub. No.: US 2016/0253290 A1
(43) Pub. Date: Sep. 1, 2016

(54) POST EXPERIMENT POWER

(71) Applicant: Linkedln Corporation, Mountain View, CA (US)

(72) Inventors: Ya Xu, Los Altos, CA (US); Weitao Duan, Mountain View, CA (US); Adrian Axel Remigo Fernandez, Mountain View, CA (US); Christina Lynn Lopus, San Francisco, CA (US); Kylan Matthew Nieh, Fremont, CA (US); Luisa Fernanda Hurtado Jaramillo, Sunnyvale, CA (US); Omar Sinno, San Francisco, CA (US); Erin Louise Delacroix, Saratoga, CA (US)

(21) Appl. No.: 14/943,624

(22) Filed: Nov. 17, 2015

Related U.S. Application Data
(60) Provisional application No. 62/126,169, filed on Feb. 27, 2015.
(60) Provisional application No. 62/140,305, filed on Mar. 30, 2015.

(51) Int. Cl. G06F 17/21; G06F 17/30; H04L 29/08

(52) U.S. Cl. CPC G06F 17/212; H04L 67/02; G06F 17/30893; G06F 17/30905

(57) ABSTRACT

Techniques for conducting A/B experimentation of online content are described. According to various embodiments, a user specification of a metric being recorded as a result of an online A/B experiment of online content is received, the online A/B experiment being targeted at a segment of members of an online social networking service. Thereafter, a power value for the A/B experiment that is associated with the metric is calculated, the power value indicating an inferred ability to detect changes in a value of the metric during performance of the A/B experiment. The power value for the A/B experiment is then displayed via a user interface displayed on a client device.

### RELATED APPLICATIONS

This application claims the benefit of priority to U.S. Provisional Application Ser. No. 62/126,169, filed Feb. 27, 2015, and U.S. Provisional Application Ser. No. 62/140,305, filed Mar. 30, 2015, which are incorporated herein by reference in their entirety.

### TECHNICAL FIELD

The present application relates generally to data processing systems and, in one specific example, to techniques for conducting A/B experimentation of online content.

### BACKGROUND

The practice of A/B experimentation, also known as “A/B testing” or “split testing,” is a practice for making improvements to webpages and other online content. A/B experimentation typically involves preparing two versions (also known as variants, or treatments) of a piece of online content, such as a webpage, a landing page, an online advertisement, etc., and providing them to separate audiences to determine which variant performs better.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 illustrates an example portion of a user interface, according to various embodiments;

FIG. 4 illustrates an example portion of a user interface, according to various embodiments;

FIG. 5 illustrates an example portion of a user interface, according to various embodiments;

FIG. 6 is a flowchart illustrating an example method, according to various embodiments;

FIG. 7 is a flowchart illustrating an example method, according to various embodiments;

FIG. 8 is a flowchart illustrating an example method, according to various embodiments;

FIG. 9 is a flowchart illustrating an example method, according to various embodiments;

FIG. 10 is a flowchart illustrating an example method, according to various embodiments;

FIG. 11 illustrates an example chart, according to various embodiments;

FIG. 12 illustrates an example portion of a user interface, according to various embodiments;

FIG. 13 illustrates an example portion of a user interface, according to various embodiments;

FIG. 14 illustrates an example portion of a user interface, according to various embodiments;

FIG. 15 illustrates an example mobile device, according to various embodiments; and

FIG. 16 is a diagrammatic representation of a machine in the example form of a computer system within which a set of instructions, for causing the machine to perform any one or more of the methodologies discussed herein, may be executed.

### DETAILED DESCRIPTION

Example methods and systems for conducting A/B experimentation of online content are described. In the following description, for purposes of explanation, numerous specific details are set forth in order to provide a thorough understanding of example embodiments. It will be evident, however, to one skilled in the art that the embodiments of the present disclosure may be practiced without these specific details.

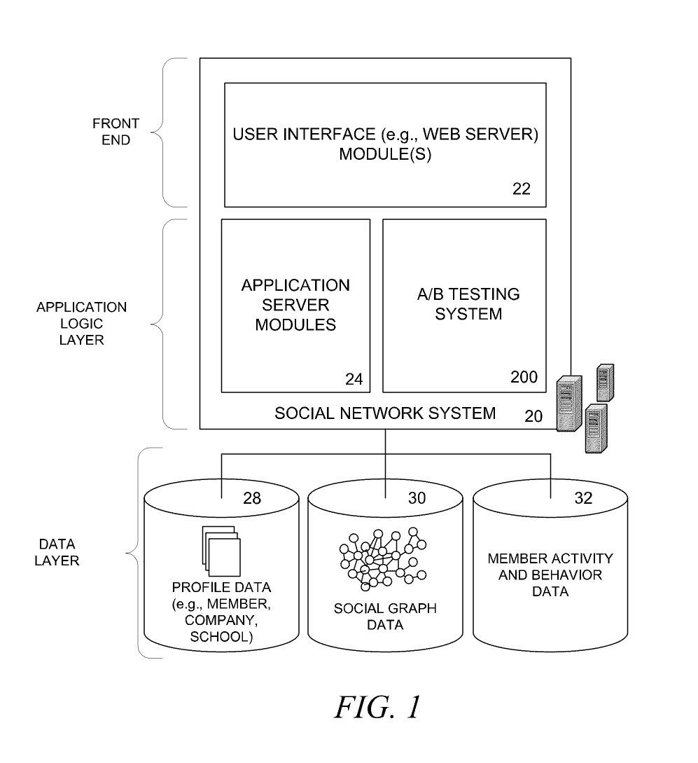

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32.

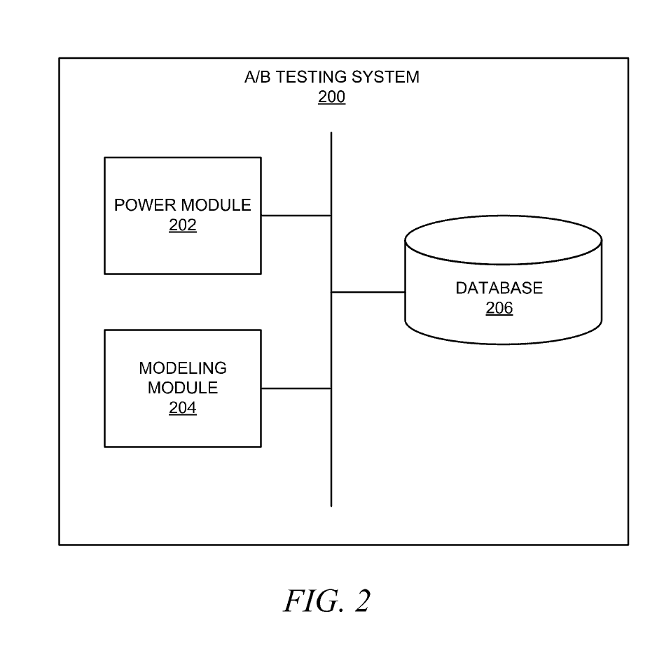

With some embodiments, the social network system 20 includes what is generally referred to herein as an A/B testing system 200. The A/B testing system 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

According to various example embodiments, an A/B testing system is configured to enable a user to prepare and conduct an A/B experiment of online content among members of an online social networking service such as LinkedIn®. The A/B testing system may display a targeting user interface allowing the user to specify targeting criteria statements that reference members of an online social networking service based on their member attributes (e.g., their member profile attributes displayed on their member profile page, or other member attributes that may be maintained by an online social networking service that may not be displayed on member profile pages). In some embodiments, the member attribute is any of location, role, industry, language, current job, employer, experience, skills, education, school, endorsements of skills, seniority level, company size, connections, connection count, account level, name, username, social media handle, email address, phone number, fax number, resume information, title, activities, group membership, images, photos, preferences, news, status, links or URLs on a profile page, and so forth. For example, the user can enter targeting criteria such as “role is sales”, “industry is technology”, “connection count>500”, “account is premium”, and so on, and the system will identify a targeted segment of members of an online social network service satisfying all of these criteria. The system can then target all of these users in the targeted segment for online A/B experimentation.

Once the segment of users to be targeted has been defined, the system allows the user to define different variants for the experiment, such as by uploading files, images, HTML code, webpages, data, etc., associated with each variant and providing a name for each variant. One of the variants may correspond to an existing feature or variant, also referred to as a “control” variant, while the other may correspond to a new feature being tested, also referred to as a “treatment”. For example, if the A/B experiment is testing a user response (e.g., click through rate or CTR) for a button on a homepage of an online social networking service, the different variants may correspond to different types of buttons such as a blue circle button, a blue square button with rounded corners, and so on. Thus, the user may upload an image file of the appropriate buttons and/or code (e.g., HTML code) associated with different versions of the webpage containing the different variants.

Thereafter, the system may display a user interface allowing the user to allocate different variants to different percentages of the targeted segment of users. For example, the user may allocate variant A to 10% of the targeted segment of members, variant B to 20% of the targeted segment of members, and a control variant to the remaining 70% of the targeted segment of members, via an intuitive and easy to use user interface. The user may also change the allocation criteria by, for example, modifying the aforementioned percentages and variants. Moreover, the user may instruct the system to execute the A/B experiment, and the system will identify the appropriate percentages of the targeted segment of members and expose them to the appropriate variants.

Turning now to FIG. 2, the A/B testing system 200 includes a power module 202, a modeling module 204, and a database 206. The modules of the A/B testing system 200 may be implemented on, or executed by, a single device such as an A/B testing device, or on separate devices interconnected via a network. The aforementioned A/B testing device may be, for example, one or more client machines or application servers. The operation of each of the aforementioned modules of the A/B testing system 200 will now be described in greater detail in conjunction with the various figures.

According to various example embodiments, the A/B testing system 200 is configured to generate a power value (e.g., a numerical value or a percentage) indicating how “powerful” a particular A/B experiment is. As described herein, the “power” of an experiment refers to the ability to detect some kind of change in a metric (e.g., page views, number of unique visitors, click through rate, etc.) being measured or recorded during the A/B experiment. For example, the larger the power value, the easier it is to detect a change in the value of metric. Further, if a power value is too low (e.g., less than a predetermine threshold, such as 80%), this may indicate that the duration or sample size of the experiment is not sufficient to detect changes in metrics associated with different variants. In this case, the A/B testing system 200 is configured to provide a recommendation on how to improve the power value of the experiment with respect to the ability to detect changes in a given metric. For example, the recommendation may be to increase the duration of the experiment, or to increase a sample size of a variant of the experiment (e.g., to increase a number of users being exposed to the variant of the experiment).

In some embodiments, the A/B testing system 200 provides a per metric recommendation function for calculating the power value and recommendation associated with each metric. For example, the A/B testing system 200 may generate a model to capture the trend for each type of metric, since each metric behaves differently (e.g., the metric of total page views for a page may tend to remain constant, whereas the metric of unique visitors may tend to decrease over time). Accordingly, the A/B testing system 200 generates a model to capture the trend for each type of metric, and given that trend, the A/B testing system 200 determines how this metric may change over time. Thus, the A/B testing system 200 can provide recommendations about how long an experiment should keep running in order to capture predicted changes in the value of the metric. For example, if there is a metric that typically won't change for X amount of time, the A/B testing system 200 will recommend that the experiment will run for at least X amount of time. Further details describing the generation of a model to capture a trend is described in more detail below.

In some embodiments, the A/B testing system 200 may generate the power value by capturing the trend for each metric. The A/B testing system 200 may capture a trend of how a metric changes by fitting a regression model to metric data for the metric from past experiments. For example, the model can be y=f(x), where x is the number of days, and y is the number of page views. Given this trend, the A/B testing system 200 may then analyze present existing metric data for the specific experiment currently being performed. For example, at present, the specific experiment may have two treatments: Treatment 1 (e.g., a blue icon, with sample size m1, and with metric data 1 (mean, variance), and Treatment 2 (e.g., a red icon, with sample size m2, and metric data 2 (mean, variance)). The A/B testing system 200 may apply this present metric data to the aforementioned model to predict future metric data after x days from the modelled trend. For example, if the mean today is 1 and the variance today is 1, application of this data to the model may reveal the mean and variance for tomorrow. Once the A/B testing system 200 has predicted future metric data from the trend, the A/B testing system 200 determines the power value after x days and uses it for recommendations (e.g., by recommending that the experiment run for the x days that provides the highest power value), as described in more detail below.

As described above, the metric data for a given variant may include mean and variance values. In probability theory and statistics, variance measures how far a set of numbers is spread out, such that a small variance indicates that the data points tend to be very close to the mean (expected value) and hence to each other, while a high variance indicates that the data points are very spread out around the mean and from each other. Thus, variance is a measure of how accurate the corresponding mean value is. In some embodiments, variance is related to, or a function of, sample size, such that different sample sizes will result in different variances (e.g., as expressed by the equation Variance=fun(n), where n is the sample size). Thus, since variance is a measure of how accurate the corresponding mean value is, and since variance is related to, or a function of, sample size, modifications to the sample size may result in improvements to the accuracy of mean values. Further, sample size can also be modelled by a trend and from the trend, new metric data may be predicted, and used to generate a power value recommendations. For example, and in one embodiment, the A/B testing system 200 generates a model of variance or sample size, and may apply different possible samples sizes n in order to identify a sample size n that results in a higher power value. Based on this, the A/B testing system 200 may provide a recommendation regarding whether to increase a ramp percentage (which is a percentage of the targeted segment to which the relevant variant is provided to). For example, the A/B testing system 200 may determine that a variance and/or sample size for a given treatment/variant can be increased by ramping a treatment/variant to a higher percentage of the targeted segment, in order to provide a higher power value.

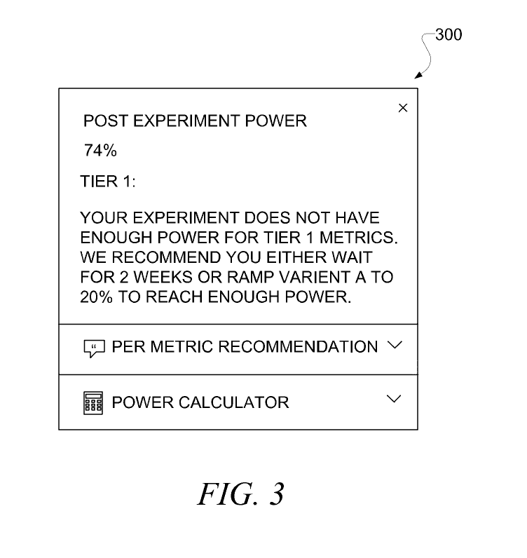

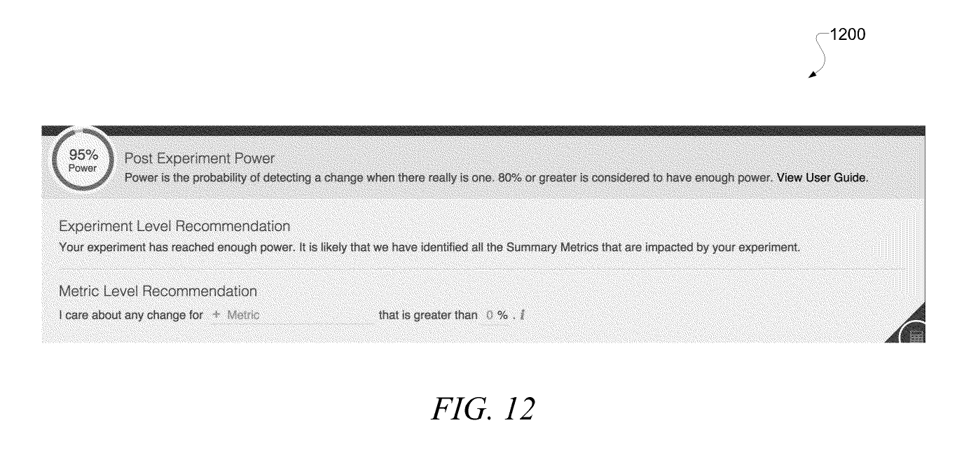

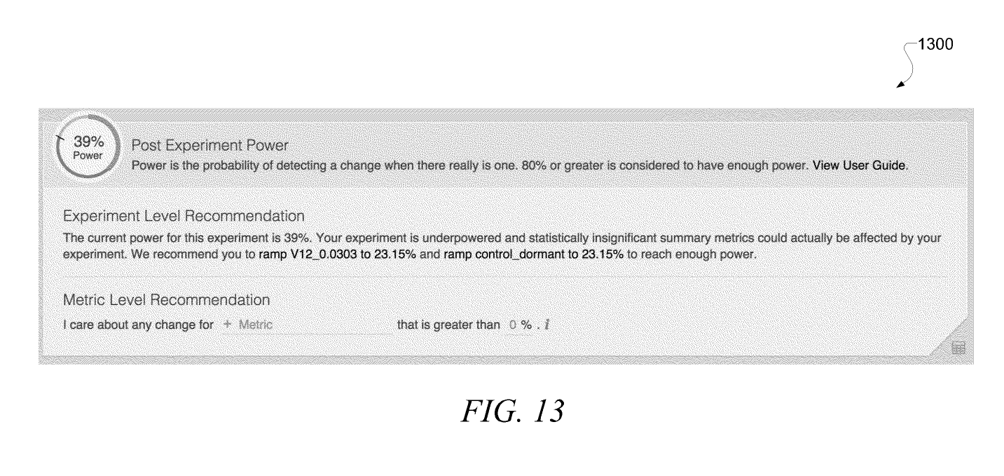

FIG. 3 illustrates an example of a post experiment power user interface 300 displayed by the A/B testing system 200 to an operator of the A/B testing system 200. The post experiment power user interface 300 indicates the power value “74%” for one or more metrics (e.g., a predefined set of metrics known as “Tier 1” metrics) for an experiment currently being performed by the A/B testing system 200. Further, the user interface 300 indicates that this power value 74% is not sufficient for the detection of changes in Tier 1 metrics. Moreover, the user interface 301 provides recommendations for increasing the power value to a higher power value sufficient for detecting changes in Tier 1 metrics, such as waiting 2 weeks or ramping variant A to 20%. See also FIGS. 12 and 13 for further examples of similar user interfaces.

Furthermore, if the user selects on the “Per Metric Recommendation” portion of the user interface 300, the A/B testing system 200 displays a “Per Metric Recommendation” user interface 400 that allows the user to specify a particular metric and an minimal detectable event (MDE) value. The user interface 400 also indicates recommendations for modifications to the A/B test to increase the power value to a level sufficient to detect changes greater than the MDE value in the specified metric. In other words, the MDE value represents the minimum effect on a metric that the user of the A/B testing system 200 cares about during performance of an A/B experiment. For example, if the user is interested in total page views on a homepage, they may set the MDE value to 2% to indicate that they only care if some change to the site as a result of the experiment increases/decreases total page view by at least 2% (with changes of 1% being too small and not required for detection). In some embodiments, the A/B testing system 200 may automatically pre-specify a default MDE (e.g., 2%) that may be changed by an operator of the A/B testing system 200.

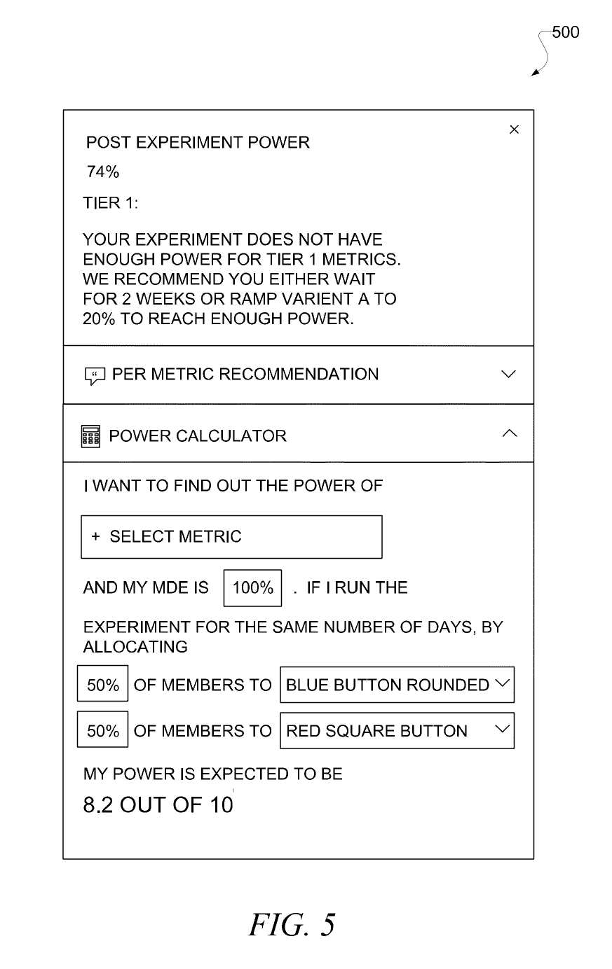

Referring back to FIG. 3, if the user selects on the “Power Calculator” portion of the user interface 300, the A/B testing system 200 displays a “Power Calculator” user interface 500 that allows the user to specify a particular metric and an MDE value, as well as a new percentage allocation of the variants of the A/B experiment to members of the online social network service. The user interface 500 displays the corresponding power level for this new allocation. Thus, the user can see the power value if they change the allocation of variants. Note that the power value may be expressed as a percentage (e.g., 74% as illustrated in FIG. 3), or as an equivalent fraction or ratio (e.g., 8.2/10 or 8.2 out of 10, as illustrated in FIG. 5).

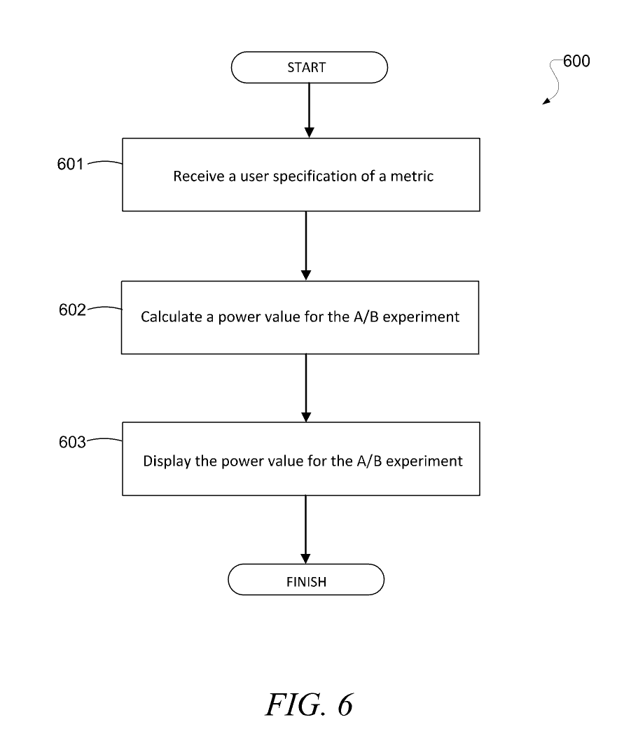

FIG. 6 is a flowchart illustrating an example method 600, consistent with various embodiments described herein. The method 600 may be performed at least in part by, for example, the A/B testing system 200 illustrated in FIG. 2 (or an apparatus having similar modules, such as one or more client machines or application servers). In operation 601, the power module 202 receives a user specification of a metric being recorded as a result of an online A/B experiment of online content, the online A/B experiment currently being targeted at a segment of members of an online social networking service. Non-limiting examples of metrics include a number of page views, a number of unique users, a number of clicks, or a click through rate. In operation 602, the power module 202 calculates a power value for the A/B experiment that is associated with the metric specified in operation 601, the power value indicating an inferred ability to detect changes in a value of the metric during performance of the A/B experiment. In some embodiments, the power value corresponds to a percentage value, a ratio, a fraction, or a number in a range (e.g., from 0 to 10 or from 0 to 100. In operation 603, the power module 202 displays, via a user interface displayed on a client device, the power value for the A/B experiment that was calculated in operation 602. It is contemplated that the operations of method 600 may incorporate any of the other features disclosed herein. Various operations in the method 600 may be omitted or rearranged, as necessary.

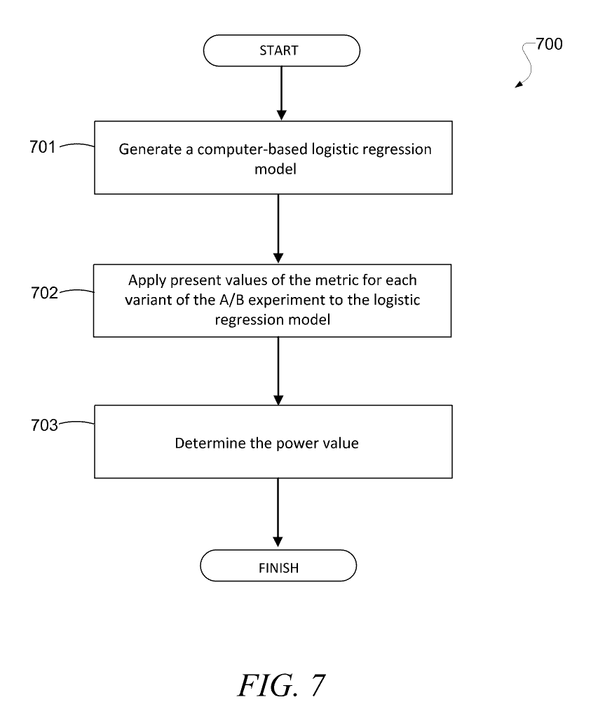

FIG. 7 is a flowchart illustrating an example method 700, consistent with various embodiments described herein. The method 700 may be performed at least in part by, for example, the A/B testing system 200 illustrated in FIG. 2 (or an apparatus having similar modules, such as one or more client machines or application servers). In operation 701, the modeling module 204 generates, based on results of prior A/B experiments, a computer-based model (e.g., logistic regression model) associated with a metric, the model indicating trends in the value of the metric over time during the prior A/B experiments. In operation 702, the power module 202 applies present values of a metric for each variant of an A/B experiment (e.g., the specific metric for the A/B experiment described in method 600) to the model generated in operation 701, in order to determine future values of the metric for each variant of the A/B experiment. In operation 703, the power module 202 determines a power value, based on the future values of the metric for each variant of the A/B experiment as determined in operation 702. For example, the power module 202 may take into account a degree of change between the future values determined in operation 702 and the present values for each variant of the A/B experiment when determining the power value. The determination of the power value is described in more detail below. It is contemplated that the operations of method 700 may incorporate any of the other features disclosed herein. Various operations in the method 700 may be omitted or rearranged, as necessary.

In some embodiments, the method 600 may further comprise receiving a user specification of a minimal detectable event (MDE) value. Further, the power value calculated in operation 602 may indicate an inferred ability to detect changes in the value of the metric greater than the minimal detectable event value during performance of the A/B experiment. For example, the operation 703 in method 700 may comprise determining that there exists a degree of change greater than the minimal detectable event value between the future values and the present values for each variant of the A/B experiment, and determining the power value, based on the degree of change for each variant of the A/B experiment. In other words, if the degree of change between the future values and the present values for a variant of the A/B experiment is less than the MDE value, this ability or inability to detected this degree of change may be disregarded during calculation of the power value.

In some embodiments, the user specification received in operation 601 specifies a plurality of metrics (e.g., a predefined set of metrics such as “Tier 1” metrics). Further, the power value calculated in operation 602 may be associated with the plurality of metrics, the power value indicating an inferred ability to detect changes in a value of one or more of the plurality of metrics during performance of the A/B experiment. The combined power value may be generated by calculating a metric-specific power value associated with each of the metrics, and calculating the combined power value based on the plurality of metric-specific power values. For example, the combined power value may correspond to the lowest of the metric-specific power values, the highest of the metric-specific power values, the mean, mode, or median of the metric-specific power values, and so on.

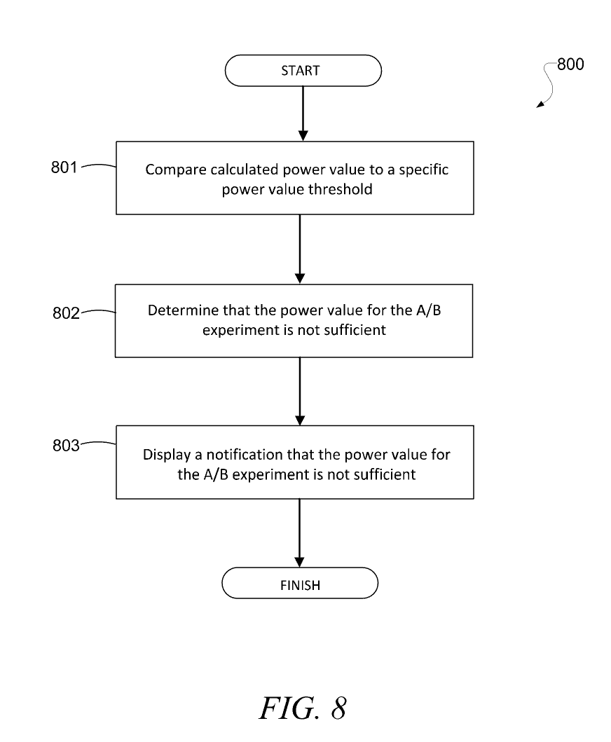

FIG. 8 is a flowchart illustrating an example method 800, consistent with various embodiments described herein. The method 800 may be performed at least in part by, for example, the A/B testing system 200 illustrated in FIG. 2 (or an apparatus having similar modules, such as one or more client machines or application servers). In operation 801, the power module 202 compares a calculated power value for an A/B experiment (e.g., the power value calculated in method 600) to a specific power value threshold. In operation 802, the power module 202 determines, based on the comparison in operation 801 (e.g., when the calculated power value is lower than the specific power value threshold), that the power value for the A/B experiment is not sufficient for detecting changes in the value of a metric during performance of the A/B experiment. In operation 803, the power module 202 displays, via a user interface displayed on a client device, a notification that the power value for the A/B experiment is not sufficient for detecting changes in the value of the metric during performance of the A/B experiment. It is contemplated that the operations of method 800 may incorporate any of the other features disclosed herein. Various operations in the method 800 may be omitted or rearranged, as necessary.

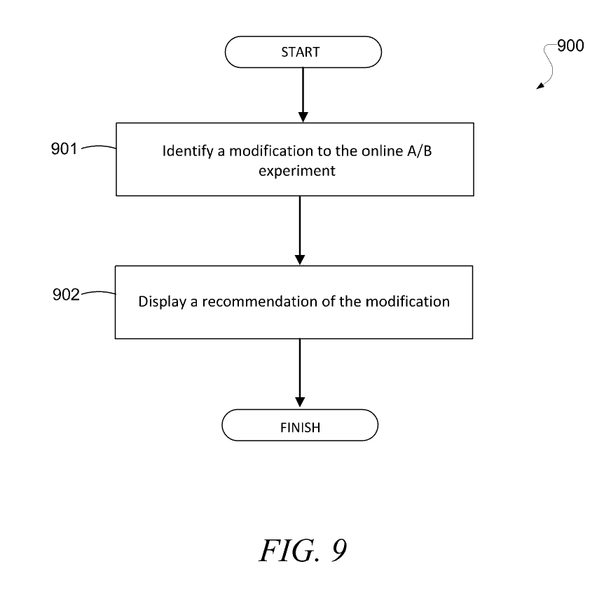

FIG. 9 is a flowchart illustrating an example method 900, consistent with various embodiments described herein. The method 900 may be performed at least in part by, for example, the A/B testing system 200 illustrated in FIG. 2 (or an apparatus having similar modules, such as one or more client machines or application servers). In operation 901, the power module 202 identifies a modification to an online A/B experiment to improve a power value (e.g., the power value described in method 600). Techniques for identifying such a modification are described in more detail in operation 1000. In some embodiments, the recommendation is to initiate a new A/B experiment wherein a particular variant of the online A/B experiment is ramped to a new percentage (e.g., from 40% to 60%) of a targeted segment of members. Thus, the A/B testing system 200 will increase/decrease the sample size of a variant by exposing the variant to more people to get more data. In some embodiments, the recommendation is to extend a duration of the online A/B experiment for a specific time interval. Thus, instead of exposing the variant to more people in the same amount of time, the A/B testing system 200 will keep exposing the variant to the same percentage of an arbitrary population, but leave it to run for more time to receive more data (e.g., so more new users will have a chance to interact with the variant). In operation 902, the power module 202 displays, via a user interface displayed on a client device, a recommendation of the modification identified in operation 901 to the online A/B experiment. It is contemplated that the operations of method 900 may incorporate any of the other features disclosed herein. Various operations in the method 900 may be omitted or rearranged, as necessary.

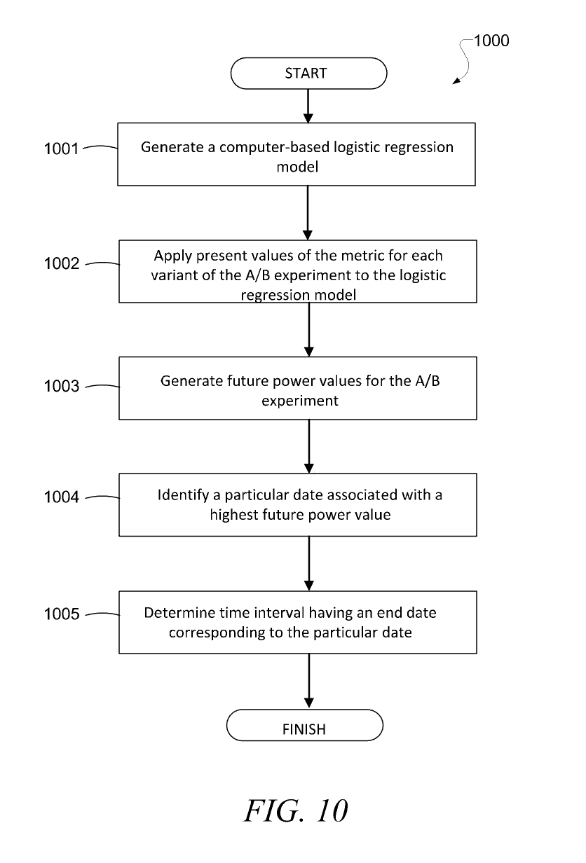

As described above, the A/B testing system 200 may generate a recommendation to extend a duration of the online A/B experiment for a specific time interval. FIG. 10 is a flowchart illustrating an example method 1000 for generating such a recommendation, consistent with various embodiments described herein. The method 1000 may be performed at least in part by, for example, the A/B testing system 200 illustrated in FIG. 2 (or an apparatus having similar modules, such as one or more client machines or application servers). In operation 1001, the modeling module 204 generates, based on results of prior A/B experiments, a computer-based model (e.g., logistic regression model) associated with a metric, the model indicating trends in the value of the metric over time during the prior A/B experiments. In operation 1002, the power module 202 applies present values of a metric for each variant of an A/B experiment (e.g., the specific metric for the A/B experiment described in method 600) to the model generated in operation 1001 to determine future values of the metric for each variant of the A/B experiment. In operation 1003, the power module 202 calculates, for each specific date in a range of future dates, based on the future values for the specific date (as determined in operation 1002), a future power value for the A/B experiment that is associated with the metric, the future power value indicating the inferred ability to detect changes in a value of the metric during performance of the A/B experiment on the specific date. In operation 1004, the power module 202 identifies a particular date in the range of future dates associated with a highest future power value (or a power value greater than a predetermined threshold). In operation 1005, the power module 202 determines that a time interval for a recommended duration of an experiment has an end date corresponding to the particular date identified in operation 1004. It is contemplated that the operations of method 1000 may incorporate any of the other features disclosed herein. Various operations in the method 1000 may be omitted or rearranged, as necessary.

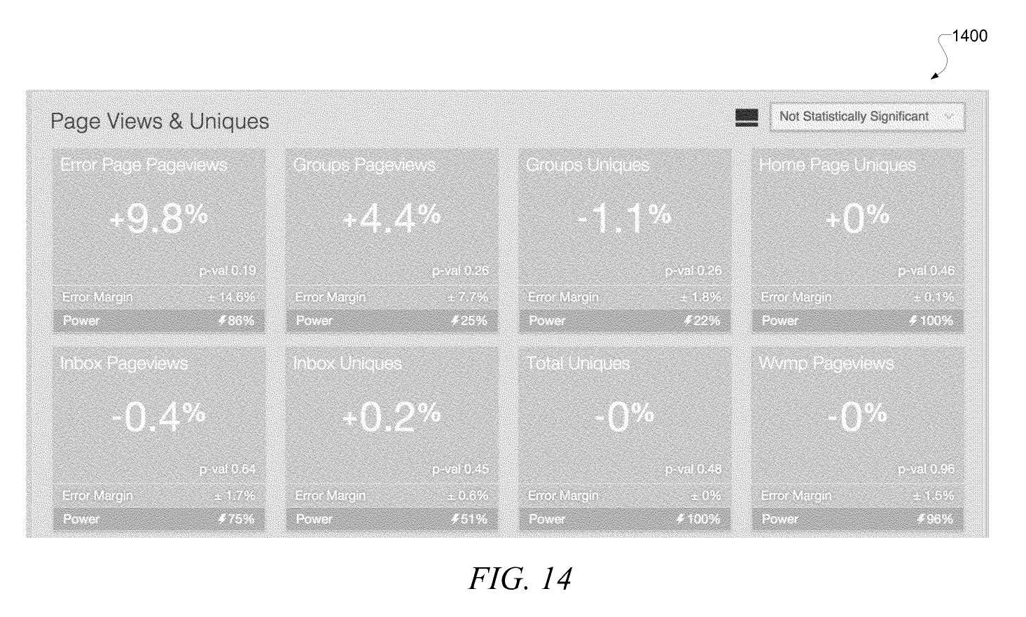

FIG. 14 illustrates an example of a user interface 1400 displayed by the system 200 that illustrates various metrics being recording during an experiment and the power value of the experiment with respect to each of the metrics.

### Example Embodiments

In some embodiments, power is a statistic to quantify the sensitivity of a test or experiment. The power of a statistical test is the probability that it correctly rejects the null hypothesis H₀ when the null hypothesis is false. In an A/B test setting, H₀ is that there is no difference between the treatment and control group. Power or P is given by:

P=Prob(reject H₀|H₀ is false)

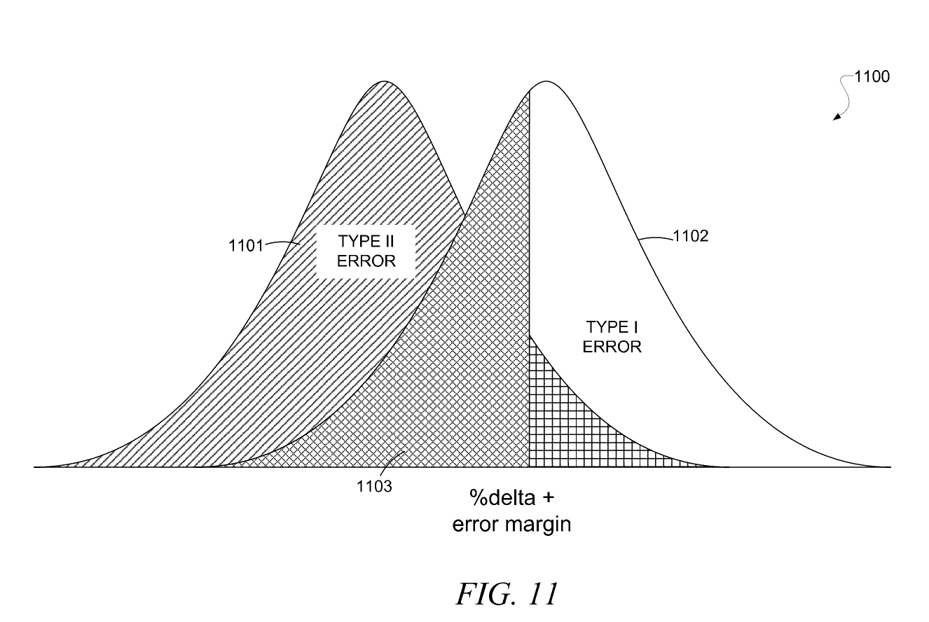

The Type II error, false negative rate, of an experiment is β and β=1−P. Referring to the chart in FIG. 11, suppose under H₀, the Δ % follows the normal distribution (1101) while the actual Δ % is greater and has the normal distribution (1102). The system 200 would fail to reject H₀ if the test statistic falls inside area 1103. This probability is the Type II error β and Power=1−β.

When analyzing the experiment test result, the system 200 monitors Type II error β as well as Type I error α. If the power is small, the system 200 is unlikely to reject the null hypothesis when the null is not true.

In the context of A/B testing, for example, the treatment effect of an experiment on the total page view is −3% (that is, if all triggered LinkedIn members are receiving the treatment, the total page views will be 3% less), and the experiment is set up in a way that that the power is merely 30%, then 70% of the time, the dashboard will not detect the treatment effect and will show total page view as a non-significant metric that is not being changed significantly. Thus, the system 200 helps achieve a relatively high power in experiments to, for example, avoid launching bad features or missing great features because no change can be detected.

In some embodiments, the system 200 performs post-experiment power analysis not pre-experiment power analysis. This is because, to find the power, the system 200 needs sample statistics such as variances V_{T}, V_{C} and sample sizes n_{T}, n_{C} for variant groups “treatment”, “control” as well as MDE. Pre-experiment power analysis involves estimating V_{T}, V_{C}, n_{T}, n_{C} where historical data can be leveraged. However, for most experiments, especially triggered experiments with complex triggering mechanism, the estimation can be far off the truth. Therefore, a pre-experiment power analysis can be problematic. After the experiment starts running and results have been collected, V_{T}, V_{C}, n_{T}, n_{C} can be estimated from the sample itself and the power values determined in power-experiment power analysis are usually more reliable.

In some embodiments, the system 200 may calculate power for a specific metric. For example, power is related to the variant means, variances and the sample sizes of the variant groups as well as significance level α and MDE. In some embodiments, the system 200 sets α=0.05. The power can be determined by:
X̅_{C} is the mean of the control group
V_{C} is the variance of the control group
V_{C}/n_{C} is the variance of mean of the control
T
represents the treatment group

$$Δ \% = \frac{{\overline{X}}_{T} - {\overline{X}}_{C}}{{\overline{X}}_{C}}$$

$${Var}_{Δ \%} = \frac{{V}_{T}}{{\overline{X}}_{C}^{2} {n}_{T}} + \frac{{\overline{X}}_{T}^{2} {V}_{C}}{{\overline{X}}_{C}^{4} {n}_{C}}$$

$${Stdev}_{Δ \%} = \sqrt{\frac{{X}_{T}^{2} {V}_{C}}{{n}_{C} {X}_{C}^{4}} + \frac{{V}_{t}}{{X}_{C}^{2} {n}_{T}}}$$

$$UpperTail = 1 - Φ ( 1.96 - \frac{MDE}{{Stdev}_{Δ \%}} )$$

$$LowerTail = Φ ( - 1.96 - \frac{MDE}{{Stdev}_{Δ \%}} )$$

$$Power = UpperTail + LowerTail$$

Thus,

Power †αsΔ%↓,n↑, and MDE↑

In some embodiments, the system 200 may take into account MDE (Minimum Detectable Effect) values. In the context of A/B testing, the MDE may correspond to the level of impact that matters to the user conducting the test. An experiment could have positive and negative impacts, and users want to have the ability to detect the improvement or deterioration on important metrics. Suppose the standard for a powerful experiment is 80%. Thus, if a user cares about 2% change in total pageviews, it means that the user wants to detect an impact of 2% or greater for tier 1 metrics 80% of the time.

Thus, the system 200 described herein provides users with information regarding whether they have enough power for a specific metric or a set of metrics (e.g., a group of metrics referred to as Summary Metrics that are considered important across a company), as well as recommendations on how to improve power (e.g., if there is currently not enough power), as well as determinations of power for a metric if member allocation percentages are changed.

In some embodiments, the system 200 may calculate the power for a group of metrics referred to as Summary Metrics that are considered important across a company. The power for a specific metric i is pᵢ. The average of power for summary metrics can be a gauge for the overall power for summary metrics. Suppose there are n summary metrics in an experiment,

$$Q = \frac{1}{n} {\sum }_{i} {p}_{i} , i ∈ \{ Summary Metrics \}$$

If Q>0.8, the experiment has enough power for summary metrics and vice versa.

In some embodiments, the system 200 may provide recommendations on how to improve the power for a metric. The key ingredients for the power are MDE and Stdev_{Δ %}. The MDE is pre-defined. Therefore, to get higher power is the same as to get smaller Stdev_{Δ%}. What affects Stdev_{Δ%} are the means, variances and sample sizes of treatment and control group. The means and variances of treatment and control group, X_{T}, X_{C}, V_{T}, V_{C}, are the group's intrinsic property. The experiment owner generally has little control over them. Thus, in order to achieve high power, the system 200 increases the sample sizes n_{C}, n_{T}.

In some embodiments, the system 200 may predict the power in the future for a metric. Predicting the power on day t can be simplified to predicting Var_{Δ %}(t) on day t. Observing that

$${Var}_{Δ \%} ( t ) = \frac{{{\overline{X}}_{T} ( t )}^{2} {V}_{C} ( t )}{{{\overline{X}}_{C} ( t )}^{4} {n}_{C} ( t )} + \frac{{V}_{T} ( t )}{{{\overline{X}}_{C} ( t )}^{2} {n}_{T} ( t )}$$

the system 200 can model the trend of X_{T}(t), X_{C}(t), V_{T}(t), V_{C}(t), n_{T}(t), n_{C}(t) to predict Var_{Δ %}(t).

The metrics measured by the system 200 include count metrics, such as total pageviews a member has made given a certain period. Suppose the metric under study in an experiment is a count metric. Looking at treatment alone, suppose on day t the metric total value (e.g. total pageviews) for that day is x_{T}(t). The system 200 assumes x_{T}(t) follows the same distribution and the random variable x_{T}(t) can be simplified to x_{T}.

If the effect of the experiment is constant over time and for simplicity, and burn-in effect is ignored,

E(x_{T})=Eα_{T}xₐₗₗN_{T}/Nₐₗₗ)

here αT is the effect ratio of the treatment group, Nₐₗₗ is the total number of online social network service members and N_{T} is the daily member counts in treatment group. x_{T} is the total metric value for the treatment group on a given day and xₐₗₗ is the daily metric total for all members. Let S_{T}(t) be the total metric value from day 1 to day t for the treatment group. Thus:

$${S}_{T} = {\sum }_{i = 1}^{t} {x}_{T} = {tx}_{T} = t {α}_{T} {x}_{all} {N}_{T} / {N}_{all}$$

$$\frac{{S}_{T} ( t + 1 )}{{S}_{T} ( t + 1 )} = \frac{t}{t + 1} = {r}_{s}$$

Assume the treatment and control sample size for this experiment grows at the same rate as the total number of members who have visited at least one online social networking service webpage, nₐₗₗ, then the trend of n_{T}(t) with respect to t can be captured by nₐₗₗ(t).

$$\frac{{n}_{T} ( t + 1 )}{{n}_{T} ( t )} = \frac{{n}_{all} ( t + 1 )}{{n}_{all} ( t )} = {r}_{n}$$

Therefore

$$\frac{E ( {\overline{X}}_{T} ( t + 1 ) )}{E ( {\overline{X}}_{T} ( t ) )} = \frac{E [ {S}_{T} ( t + 1 ) / {n}_{T} ( t + 1 ) ]}{E [ {S}_{T} ( t ) / {n}_{T} ( t ) ]} = \frac{( t + 1 ) {n}_{T} ( t )}{{tn}_{T} ( t + 1 )}$$

The sample variance on day t for the treatment group

Var_{T}(t)=Σₜ₌₁^{n(t)}(xⁱ(t)−X̅(t))²/n(t),xⁱ(t)

is the total metric value from member i up to day t. The system 200 assumes

X_{T,i}(t)=α_{T}X_{all,i}(t)

the metric value of member i up to day t without the treatment effect. The system 200 can approximate

$${Var}_{T} ( t ) = {\sum }_{i = 1}^{n ( t )} {( {x}_{T}^{i} - \overline{X} ( t ) )}^{2} / n ( t )$$

by

$$E ( {Var}_{T} ( t ) ) = {\sum }_{i = 1}^{n ( i )} E [ {( {X}_{i} - \overline{X} ( t ) )}^{2} / n ( t ) ] = {n}_{T} ( t ) / {n}_{all} ( t ) {α}_{T}^{2} E ( {V}_{all} ) = {r}_{p}$$

In some embodiments, nₐₗₗ(t), Vₐₗₗ(t) is captured in a dummy test

$$\frac{E ( {V}_{T} ( t ) ) / {n}_{T} ( t )}{E ( {V}_{all} ( t ) ) / {n}_{all} ( t )} = \frac{E ( {V}_{T} ( t - 1 ) ) / {n}_{T} ( t - 1 )}{E ( {V}_{all} ( t - 1 ) ) / {n}_{all} ( t - 1 )}$$

Trend of nₐₗₗ, Vₐₗₗ can be modeled from a dummy test. Studies show that nₐₗₗ, Vₐₗₗ can be well captured by a second degree polynomial model. The variance of (\Delta \%) on day t+1 can then be approximated by the system 200 by:

$${Var}_{Δ \%} ( t + 1 ) = \frac{\overline{{X}_{T}^{2}} {V}_{C}}{\overline{{X}_{C}^{4}} {n}_{C}} \frac{{r}_{n} {r}_{v}}{{r}_{s}^{2}} + \frac{{V}_{T}}{\overline{{X}_{c}^{2}} {n}_{T}} \frac{{r}_{n} {r}_{v}}{{r}_{s}^{2}}$$

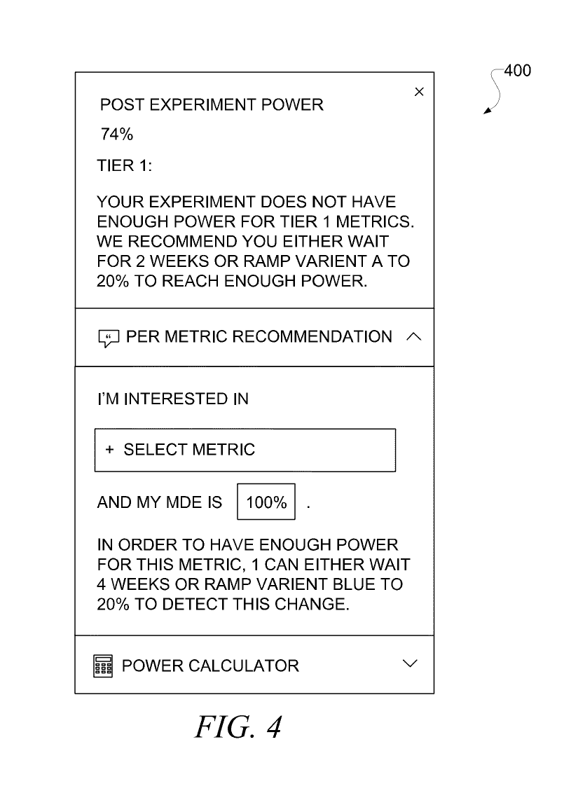

In some embodiments, the system 200 may provide a recommendation on how to increase power for a metric (see FIG. 4). For example, the system 200 may recommend running the experiment for a longer time period. For example, suppose an experiment has been running on XLNT for a few days. The system 200 has collected data on X_{T}, X_{C}, V_{T}, V_{C}, n_{T}, n_{C}, on day t. The system 200 can use the formula above to predict Var_{Δ %}(t+t′), the variance of Delta % t′ days later. The power for the metric on day t+t′, P(t+t′), is a function of Var_{Δ %}(t+t′):

P(t+t′)=f(Var_{Δ %}(t+t′))

The system 200 can find the t′ such that P(t+t′) is greater than a predetermined threshold (e.g., 0.8). Thus, the system 200 may recommend that the experiment needs to run t′ more days to get enough power.

In some embodiments, the system 200 may recommend how to allocate traffic to achieve enough power. For example, suppose the system 200 fixes the experiment run time to be t days. The variance of Delta % under the allocation n′_{T},n′_{C}, Var′_{Δ %}, is expected to be

$${Var}_{Δ \%}^{′} ( t ) = \frac{{{\overline{X}}_{T} ( t )}^{2} {V}_{C} ( t )}{{{\overline{X}}_{C} ( t )}^{4} {n}_{C}^{′} ( t )} + \frac{{V}_{T} ( t )}{{{\overline{X}}_{C} ( t )}^{2} {n}_{T}^{′} ( t )}$$

The system 200 can reallocate the members in the experiment to n′_{T},n′_{C} to get higher power. In this example, a (50, 50) split between treatment and control group gives the best power.

As described herein, in some embodiments, the system 200 provides power recommendation for summary metrics (see FIG. 4). Similar to the one metric case, the recommendations provided for summary metrics aim to achieve Q>0.8.

As described herein, in some embodiments, the system 200 provides a power calculator for a metric (see FIG. 5). For example, the variance of Delta % under the allocation n′_{T},n′_{C}, Var′_{Δ %}, is expected to be

$${Var}_{Δ \%}^{′} ( t ) = \frac{{{\overline{X}}_{T} ( t )}^{2} {V}_{C} ( t )}{{{\overline{X}}_{C} ( t )}^{4} {n}_{C}^{′} ( t )} + \frac{{V}_{T} ( t )}{{{\overline{X}}_{C} ( t )}^{2} {n}_{T}^{′} ( t )}$$

Thus, the system 200 calculates the power for the specified allocation based on Var′_{Δ %}(t).

### Example Mobile Device

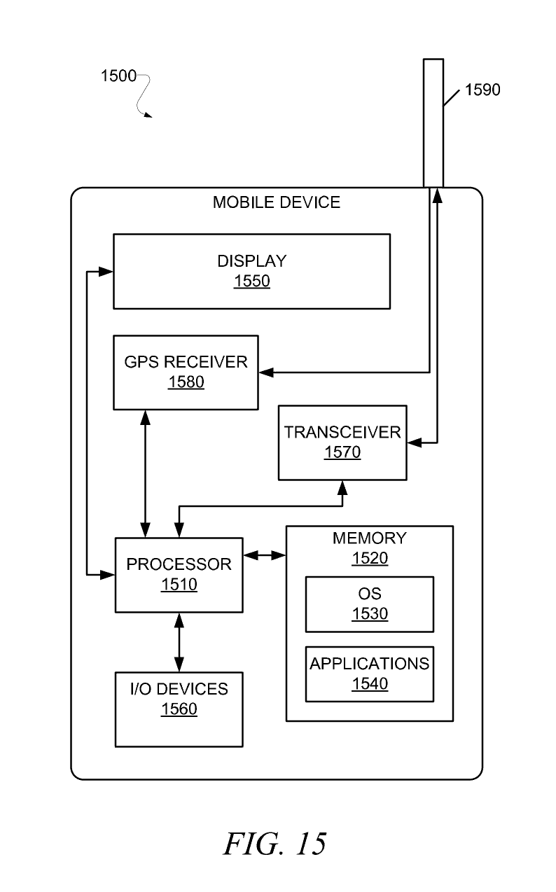

FIG. 15 is a block diagram illustrating the mobile device 1500, according to an example embodiment. The mobile device may correspond to, for example, one or more client machines or application servers. One or more of the modules of the system 200 illustrated in FIG. 2 may be implemented on or executed by the mobile device 1500. The mobile device 1500 may include a processor 1510. The processor 1510 may be any of a variety of different types of commercially available processors suitable for mobile devices (for example, an XScale architecture microprocessor, a Microprocessor without Interlocked Pipeline Stages (MIPS) architecture processor, or another type of processor). A memory 1520, such as a Random Access Memory (RAM), a Flash memory, or other type of memory, is typically accessible to the processor 1510. The memory 1520 may be adapted to store an operating system (OS) 1530, as well as application programs 1540, such as a mobile location enabled application that may provide location based services to a user. The processor 1510 may be coupled, either directly or via appropriate intermediary hardware, to a display 1550 and to one or more input/output (I/O) devices 1560, such as a keypad, a touch panel sensor, a microphone, and the like. Similarly, in some embodiments, the processor 1510 may be coupled to a transceiver 1570 that interfaces with an antenna 1590. The transceiver 1570 may be configured to both transmit and receive cellular network signals, wireless data signals, or other types of signals via the antenna 1590, depending on the nature of the mobile device 1500. Further, in some configurations, a GPS receiver 1580 may also make use of the antenna 1590 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

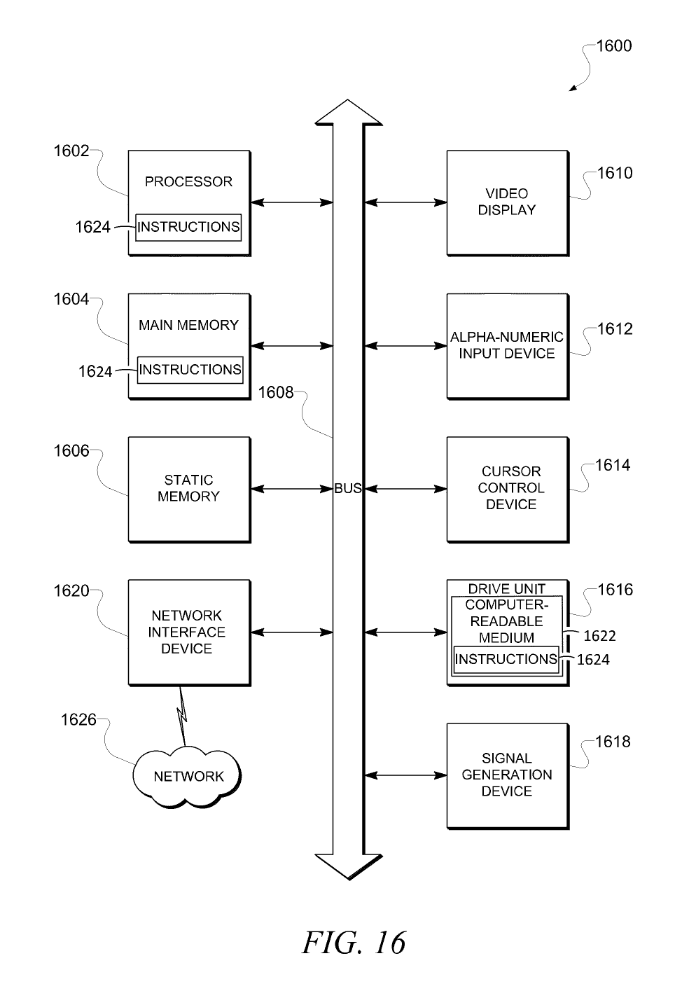

FIG. 16 is a block diagram of machine in the example form of a computer system 1600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1602 (e.g., a central processing unit (CPU), a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard or a touch-sensitive display screen), a user interface (UI) navigation device 1614 (e.g., a mouse), a disk drive unit 1616, a signal generation device 1618 (e.g., a speaker) and a network interface device 1620.

### Machine-Readable Medium

The disk drive unit 1616 includes a machine-readable medium 1622 on which is stored one or more sets of instructions and data structures (e.g., software) 1624 embodying or utilized by any one or more of the methodologies or functions described herein. The instructions 1624 may also reside, completely or at least partially, within the main memory 1604 and/or within the processor 1602 during execution thereof by the computer system 1600, the main memory 1604 and the processor 1602 also constituting machine-readable media.

While the machine-readable medium 1622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1624 may further be transmitted or received over a communications network 1626 using a transmission medium. The instructions 1624 may be transmitted using the network interface device 1620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving, by at least one hardware processor, a user specification of a metric being recorded as a result of an online A/B experiment of online content, the online A/B experiment being targeted at a segment of members of an online social networking service;
calculating, by at least one hardware processor, a power value for the A/B experiment that is associated with the metric, the power value indicating an inferred ability to detect changes in a value of the metric during performance of the A/B experiment; and
transmitting, by the at least one hardware processor, the power value for the A/B experiment to be displayed on a user interface displayed on a client device.

2. The method of claim 1, wherein the calculating further comprises:
generating, based on results of prior A/B experiments, a computer-based model associated with the metric, the model indicating trends in the value of the metric over time during the prior A/B experiments;
applying present values of the metric for each variant of the A/B experiment to the model to determine future values of the metric for each variant of the A/B experiment; and
determining the power value, based on the determined future values of the metric for each variant of the A/B experiment.

3. The method of claim 1, further comprising:
comparing the calculated power value to a specific power value threshold;
determining, based on the comparison, that the power value for the A/B experiment is not sufficient for detecting changes in the value of the metric during performance of the A/B experiment; and
displaying, via the user interface displayed on the client device, a notification that the power value for the A/B experiment is not sufficient for detecting changes in the value of the metric during performance of the A/B experiment.

4. The method of claim 1, further comprising:
identifying a modification to the online A/B experiment to improve the power value; and
displaying, via the user interface displayed on the client device, a recommendation of the modification to the online A/B experiment.

5. The method of claim 4, wherein the recommendation is to extend a duration of the online A/B experiment for a specific time interval.

6. The method of claim 5, wherein the identifying further comprises:
generating, based on results of prior A/B experiments, a computer-based model associated with the metric, the model indicating trends in the value of the metric over time during the prior A/B experiments;
applying present values of the metric for each variant of the A/B experiment to the model to determine future values of the metric for each variant of the A/B experiment;
calculating, for each specific date in a range of future dates, based on the future values for the specific date, a future power value for the A/B experiment that is associated with the metric, the future power value indicating the inferred ability to detect changes in a value of the metric during performance of the A/B experiment on the specific date;
identifying a particular date in the range of future dates associated with a highest future power value; and
determining that the specific time interval has an end date corresponding to the particular date.

7. The method of claim 4, wherein the recommendation is to initiate a new A/B experiment wherein a particular variant of the online A/B experiment that is ramped to a particular percentage of the targeted segment of members during the online A/B experiment is ramped to a new percentage of the targeted segment of members in the new A/B experiment.

8. The method of claim 1, wherein the metric corresponds to a number of page views, a number of unique users, a number of clicks, or a click through rate.

9. The method of claim 1, wherein the power value corresponds to a percentage value.

10. The method of claim 1, further comprising receiving a user specification of a minimal detectable event value,
wherein the power value for the A/B experiment indicates an inferred ability to detect changes in the value of the metric greater than the minimal detectable event value during performance of the A/B experiment.

11. The method of claim 10, wherein the calculating further comprises:
generating, based on results of prior A/B experiments, a computer-based model associated with the metric, the model indicating trends in the value of the metric over time during the prior A/B experiments;
applying present values of the metric for each variant of the A/B experiment to the model to determine future values of the metric for each variant of the A/B experiment;
determining that a degree of change greater than the minimal detectable event value exists between the future values and the present values for each variant of the A/B experiment; and
determining the power value, based on the degree of change for each variant of the A/B experiment.

12. The method of claim 1, wherein the received user specification specifies a plurality of metrics including the metric, and wherein the calculated power value is associated with the plurality of metrics including the metric, the power value indicating an inferred ability to detect changes in a value of one or more of the plurality of metrics during performance of the A/B experiment.

13. The method of claim 12, wherein the power value associated with the plurality of metrics is generated by:
calculating a plurality of metric-specific power values associated with the plurality of metrics; and
calculating the power value based on the plurality of metric-specific power values.

14. A system comprising:
a processor; and
a memory device holding an instruction set executable on the processor to cause the system to perform operations comprising:
receiving a user specification of a metric being recorded as a result of an online A/B experiment of online content, the online A/B experiment being targeted at a segment of members of an online social networking service;
calculating a power value for the A/B experiment that is associated with the metric, the power value indicating an inferred ability to detect changes in a value of the metric during performance of the A/B experiment; and
displaying, via a user interface displayed on a client device, the power value for the A/B experiment.

15. The system of claim 14, wherein the calculating further comprises:
generating, based on results of prior A/B experiments, a computer-based model associated with the metric, the model indicating trends in the value of the metric over time during the prior A/B experiments;
applying present values of the metric for each variant of the A/B experiment to the model to determine future values of the metric for each variant of the A/B experiment; and
determining the power value, based on the determined future values of the metric for each variant of the A/B experiment.

16. The system of claim 14, further comprising:
comparing the calculated power value to a specific power value threshold;
determining, based on the comparison, that the power value for the A/B experiment is not sufficient for detecting changes in the value of the metric during performance of the A/B experiment; and
displaying, via the user interface displayed on the client device, a notification that the power value for the A/B experiment is not sufficient for detecting changes in the value of the metric during performance of the A/B experiment.

17. The system of claim 14, further comprising:
identifying a modification to the online A/B experiment to improve the power value; and
displaying, via the user interface displayed on the client device, a recommendation of the modification to the online A/B experiment.

18. The system of claim 17, wherein the recommendation is to extend a duration of the online A/B experiment for a specific time interval.

19. The system of claim 17, wherein the recommendation is to initiate a new A/B experiment wherein a particular variant of the online A/B experiment that is ramped to a particular percentage of the targeted segment of members during the online A/B experiment is ramped to a new percentage of the targeted segment of members in the new A/B experiment.

20. A non-transitory machine-readable storage medium comprising instructions that, when executed by one or more processors of a machine, cause the machine to perform operations comprising:
receiving a user specification of a metric being recorded as a result of an online A/B experiment of online content, the online A/B experiment being targeted at a segment of members of an online social networking service;
calculating a power value for the A/B experiment that is associated with the metric, the power value indicating an inferred ability to detect changes in a value of the metric during performance of the A/B experiment; and
displaying, via a user interface displayed on a client device, the power value for the A/B experiment.
